(19) United States
(12) Patent Application Publication
(10) Pub. No.: US 2008/0311453 A1
(43) Pub. Date: Dec. 18, 2008

(54) FUEL CELL SYSTEM AND FUEL CELL VEHICLE

(75) Inventor: Kenji KOBAYASHI, Shizuoka (JP)

Correspondence Address: YAMAHA HATSUDOKI KABUSHIKI KAISHA;C/O KEATING & BENNETT, LLP, 1800 Alexander Bell Drive, SUITE 200, Reston, VA, 20191, US

(73) Assignee: Yamaha Hatsudoki Kabushiki Kaisha, Iwata-shi (JP)

(21) Appl. No.: 12/138,642

(22) Filed: Jun. 13, 2008

(30) Foreign Application Priority Data
Jun. 15, 2007 (JP) 2007-158895

(51) Int. Cl. H01M 8/04; H02J 3/00; F04B 49/06

(52) U.S. Cl. 429/23; 429/26; 320/101; 417/44.1

(57) ABSTRACT

In a fuel cell device, when a fuel cell device is not operated and an external power source enabling a battery charge of a secondary battery is connected to the secondary battery, a controller is provided to operate a water pump to circulate the cooling water via a circulation pipeline. The fuel cell prevents cooling water for cooling a fuel cell from corroding or freezing while a secondary battery and the fuel cell are used together.

### BACKGROUND OF THE INVENTION

1. Field of the Invention

The present invention relates to a fuel cell system and a fuel cell vehicle arranged to run by rotationally driving a wheel by an electric motor supplied with electricity by at least one of a secondary battery and a fuel cell device.

2. Description of the Related Art

A fuel cell system and a fuel cell vehicle of the above type is arranged to keep a fuel cell at a predetermined temperature by circulating cooling water via a circulation pipeline with a water pump while the fuel cell is generating electricity. In this case, an ion removing filter is arranged in the circulation pipeline to remove electroconductive ions dissolved in the cooling water (see JP-A-2005-235489, for example).

On the other hand, a secondary battery chargeable by an external power source may be mounted on a fuel cell vehicle to reduce consumption of the hydrogen gas fuel as much as possible. The secondary battery is mainly used as a power source during normal running, and the fuel cell device is operated in accordance with the state of discharge of the secondary battery or with a running condition of the vehicle.

When the conventional fuel cell vehicle is arranged to run with the secondary battery chargeable by an external power source as a main power source, frequently there are cases in which the vehicle does not use the fuel cell device very often during running. If such cases are repeated during running of the vehicle, the cooling water for cooling the fuel cell is not circulated adequately. Accordingly, the cooling water may deteriorate and corrode at an early stage, and the cooling water may freeze if left outside for a long time in cold weather.

### SUMMARY OF THE INVENTION

In order to overcome the problems described above, preferred embodiments of the present invention provide a fuel cell system and a fuel cell vehicle which prevents the cooling water for cooling a fuel cell from corroding or freezing when a secondary battery and the fuel cell are used together.

A first preferred embodiment of the present invention is a fuel cell system including a fuel cell device, a secondary battery chargeable by the fuel cell device, a cooling system including a water pump arranged to circulate cooling water for cooling the fuel cell device via a circulation pipeline, and a pump operation controller arranged to operate the water pump to circulate the cooling water via the circulation pipeline during a period of time when the fuel cell device is not operated and an external power source arranged to charge the secondary battery is connected to the secondary battery.

Another preferred embodiment of the present invention is directed to the fuel cell system described above, in which the pump operation controller is arranged to operate the water pump by electric power from the external power source during the period of time.

Another preferred embodiment of the present invention is directed to the fuel cell system described above, in which the pump operation controller stops an operation of the water pump when connection of the external power source to the secondary battery is disabled.

Another preferred embodiment of the present invention is directed to the fuel cell system described above, in which the pump operation controller operates the water pump during the period of time with an output lower than that for when the fuel cell is operated during normal operation.

Another preferred embodiment of the present invention is directed to the fuel cell system described above, in which a conductivity decreasing device is provided to decrease the conductivity of the cooling water flowing through the circulation pipeline.

Another preferred embodiment of the present invention is directed to the fuel cell system described above, further including a power source controller arranged to supply electric power to the secondary battery from the external power source during the period of time, wherein the power source controller stops supplying electric power to the secondary battery from the external power source when an amount of the battery charge of the secondary battery exceeds a specified value during the period of time.

Another preferred embodiment of the present invention is directed to the fuel cell system described above, further including a power source controller arranged to supply electric power to the secondary battery and the conductivity decreasing device from the external power source during the period of time, wherein the power source controller stops supplying electric power to the secondary battery from the external power source when an amount of the battery charge of the secondary battery exceeds a specified value during the period of time.

Another preferred embodiment of the present invention is directed to the fuel cell system described above, in which the power source controller stops supplying electric power to the secondary battery and the conductivity decreasing device from the external power source when a connection of the external power source to the secondary battery is disabled.

Another preferred embodiment of the present invention is directed to the fuel cell system described above, in which the conductivity decreasing device preferably includes an electric ion removing device, wherein the power source controller supplies electric power to the secondary battery and the electric ion removing device from the external power source during the period of time.

Another preferred embodiment of the present invention is directed to the fuel cell system described above, in which the conductivity decreasing device preferably includes an ion exchange resin type ion removing device arranged in a bypass pipeline bypassing the circulation pipeline and a switch arranged to permit or restrict a flow of the cooling water to the bypass pipeline, wherein the power source controller supplies electric power to the secondary battery and the switch from the external power source during the period of time.

Another preferred embodiment of the present invention is directed to the fuel cell system described above, in which the switch preferably includes an electromotive three-way valve.

Another preferred embodiment of the present invention is directed to the fuel cell system described above, in which the conductivity decreasing device preferably includes an ion exchange resin type ion removing device arranged in a bypass pipeline bypassing the circulation pipeline and a switch arranged to permit or restrict a flow of the cooling water to the bypass pipeline, wherein the switch is preferably a three-way valve of an automatic temperature sensing type containing a shape memory alloy and switches a route of the cooling water from the circulation pipeline to the bypass pipeline or from the bypass pipeline to the circulation pipeline when a temperature of the cooling water reaches a specified temperature.

Another preferred embodiment of the present invention is a fuel cell vehicle including the fuel cell system according to any of the preferred embodiments described above, and an electric motor supplied with electricity by at least one of the secondary battery and the fuel cell device to drive a wheel of the vehicle.

According to the fuel cell system of a preferred embodiment described above, during a period of time when the fuel cell device is not operated and when the external power source is connected to the secondary battery, the water pump is operated to circulate the cooling water. Accordingly, it is possible to prevent the cooling water from corroding due to stagnant cooling water and to prevent the cooling water from freezing in cold weather. As a result, for example, even if there are frequent cases in which the secondary battery is mainly used as a power source and the fuel cell device is not used very often during running, it is possible to prevent the cooling water from deteriorating at an early stage, and it is also possible to prevent the fuel cell device from being damaged due to the cooling water freezing.

Further, when the external power source is connected to the secondary battery, the water pump is automatically operated. Accordingly, manual operation for circulating the cooling water is not necessary.

According to a preferred embodiment described above, the power source for operating the water pump is supplied from the external power source. Accordingly, it is possible to avoid a problem in which the electric power of the secondary battery is unnecessarily reduced in the case in which the water pump is operated with the secondary battery as a power source.

According to a preferred embodiment described above, when connection of the external power source to the secondary battery is disabled, an operation of the water pump is stopped. Accordingly, manual operation for stopping the water pump is not necessary.

According to a preferred embodiment described above, the water pump is operated during the period of time by an output lower than that for a normal operation of the fuel cell. Accordingly, an output lower than that for cooling the fuel cell device or, in other words, only an output of a minimum requirement for circulating the cooling water is necessary. As a result, power consumption can be reduced.

According to a preferred embodiment described above, conductivity of the cooling water flowing through the circulation pipeline is decreased. Accordingly, an operation for decreasing conductivity of the cooling water can be performed at the same time when the cooling water is circulated. As a result, any special operation for decreasing the conductivity of the cooling water is not necessary.

According to a preferred embodiment described above, the battery charge power source and the operation power source are supplied to the secondary battery and to the water pump, respectively, via the distributor from the external power source and when an amount of the battery charge of the secondary battery exceeds the specified value, supply of the battery charge power source to the secondary battery is stopped. Accordingly, even when the battery charge of the secondary battery is ended, the operation power source is kept supplied to the water pump. Consequently, the cooling water can be kept circulating until connection of the external power source is disabled. As a result, it is possible to further prevent the cooling water from corroding or freezing.

According to a preferred embodiment above, the battery charge power source, the operation power source and the device operation power source are supplied to the secondary battery, to the water pump, and to the conductivity decreasing device, respectively, via the distributor from the external power source. In addition, when an amount of the battery charge of the secondary battery exceeds the specified value, the supply of the battery charge power source to the secondary battery is stopped. Accordingly, even when the battery charge of the secondary battery is ended, the power source can be kept supplied to the water pump and the conductivity decreasing device. As a result, the circulation of the cooling water and the operation for removing ions can be continued.

Further, the power source for operating the water pump and the ion removing device is supplied from the external power source. Accordingly, it is possible to avoid a problem in which the electric power of the secondary battery is unnecessarily reduced as a case in which the secondary battery is the power source.

According to a preferred embodiment described above, when connection of the external power source to the secondary battery is disabled, the device operation power source to the conductivity decreasing device is also stopped. As a result, it is possible to avoid a problem in which the electric power of the secondary battery is unnecessarily reduced as the case in which the secondary battery is the power source.

According to a preferred embodiment described above, the electric ion removing device includes a switch, and a switching power source is supplied to the electric ion removing device via the distributor from the external power source. Accordingly, the switching power source can be supplied from the external power source as a result, and it is possible to avoid a problem in which the electric power of the secondary battery is unnecessarily reduced as the case in which the switching power source is supplied from the secondary battery.

According to a preferred embodiment described above, the ion exchange resin type ion removing device and the switch are arranged in the bypass pipeline bypassing the circulation pipeline, and the battery charge power source and the operation power source are supplied to the secondary battery and to the water pump, respectively, via the distributor from the external power source. In addition, when an amount of the battery charge of the second battery exceeds the specified value, the supply of the battery charge power source to the secondary battery is stopped. Accordingly, even when the battery charge of the secondary battery is ended, the operation power source can be supplied to the water pump from the external power source as a result, and it is possible to avoid a problem in which the electric power of the secondary battery is unnecessarily reduced as the case in which the operation power source is supplied to the water pump from the secondary battery.

According to a preferred embodiment described above, the switch is preferably an electromotive three-way valve, and the switching power source is supplied to the electromotive three-way valve via the distributor from the external power source. Accordingly, the switching power source can be supplied from the external power source as a result, and it is possible to avoid a problem in which the electric power of the secondary battery is unnecessarily reduced as the case in which the switching power source is supplied from the secondary battery.

According to a preferred embodiment described above, the switch is preferably an electromotive three-way valve of an automatic temperature sensing type. Accordingly, the power source for operating the switch is not necessary.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a system configuration diagram of the fuel cell vehicle according to a first preferred embodiment of the present invention.

FIG. 2 is a flow chart illustrating an operation of the fuel cell vehicle.

FIG. 3 is a system configuration diagram of the fuel cell vehicle according to a second preferred embodiment of the present invention.

FIG. 4 is a flow chart illustrating an operation of the fuel cell vehicle.

FIG. 5 is a flow chart illustrating an operation in a case in which the three-way valve of an automatic temperature sensing type is used according to a modified example of the second preferred embodiment.

### DETAILED DESCRIPTION OF PREFERRED EMBODIMENTS

Preferred embodiments of the present invention will be described hereinafter with reference to the accompanying drawings. The preferred embodiments are preferably cases in which a fuel cell system 100 is provided in a vehicle.

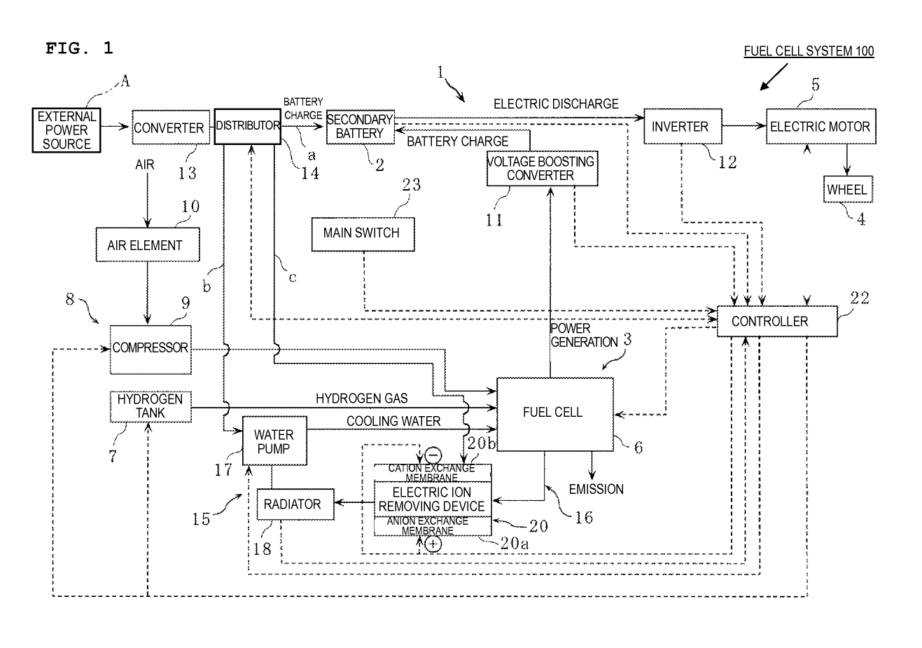

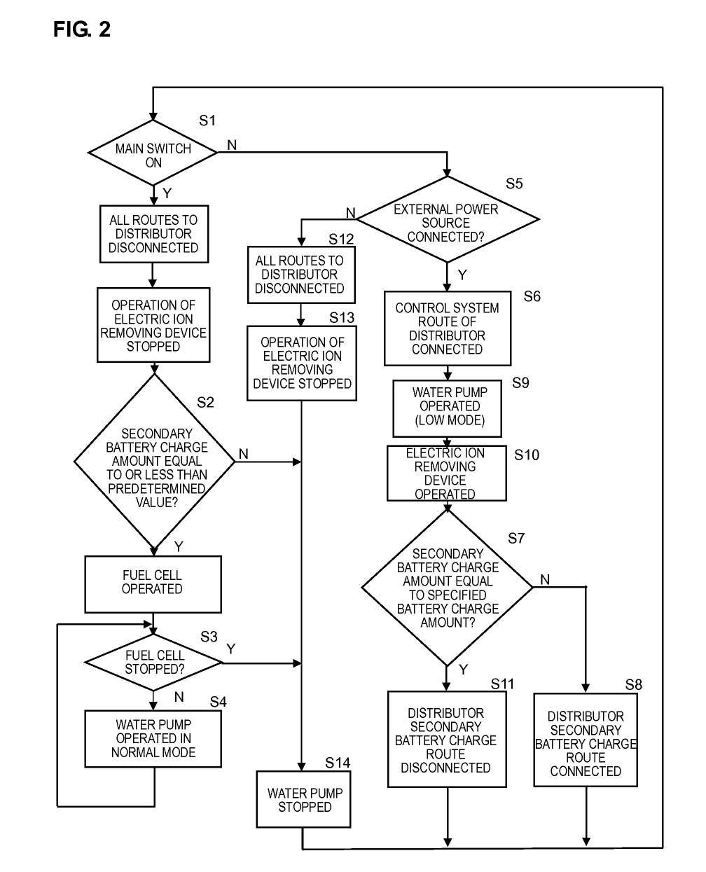

FIG. 1 and FIG. 2 are drawings for describing a fuel cell vehicle according to a first preferred embodiment of the present invention. FIG. 1 is a block diagram of the fuel cell vehicle, and FIG. 2 is a flow chart for describing an operation of the fuel cell vehicle.

In the drawings, reference numeral 1 denotes a system configuration of a fuel cell vehicle including a secondary battery 2 mounted on the vehicle (not shown), a fuel cell device 3, and an electric motor 5 supplied with electricity by at least one of the secondary battery 2 and the fuel cell device 3 to rotatably drive a wheel 4.

The fuel cell device 3 has a fuel cell 6, a hydrogen tank 7 for supplying hydrogen gas to the fuel cell 6, and an air supply section 8 for supplying compressed air to the fuel cell 6. The air supply section 8 has a compressor 9 for compressing air and an air element 10 for filtering air passing into the compressor 9.

The fuel cell 6 causes an electrochemical reaction of the hydrogen gas supplied from the hydrogen tank 7 with the compressed air supplied from the compressor 9 and converts chemical energy into electric energy to generate electricity. The generated electric power is supplied to the secondary battery 2 via a voltage boosting converter 11 for boosting a voltage from the fuel cell 6 to a voltage for the secondary battery and charges the secondary battery 2.

The fuel cell vehicle 1 is provided with a fuel cell cooling device 15 for cooling the fuel cell 6 during power generation to keep the fuel cell 6 at a predetermined temperature (for example, about 60° C. to about 80° C.).

The fuel cell cooling device 15 has a circulation pipeline 16 for circulating cooling water for cooling the fuel cell 6 between the fuel cell 6 and a radiator 18, a water pump 17 arranged in a middle of the circulation pipeline 16 for supplying the cooling water to the fuel cell 6, and the radiator 18 arranged at an upstream side of the water pump 17 of the circulation pipeline 16 for cooling the cooling water having passed through the fuel cell 6. In this case, the fuel cell cooling device 15 functions as the cooling system.

Further, an electric ion removing device 20 which functions as a conductivity decreasing device arranged to decrease the conductivity of the cooling water flowing in the circulation pipeline 16 is arranged between the fuel cell 6 and the radiator 18 of the circulation pipeline 16. The electric ion removing device 20 removes electroconductive ions in the cooling water by an anion exchange membrane 20a and a cation exchange membrane 20b.

A converter 13 is connected to the secondary battery 2 via a distributor 14. The converter 13 converts an alternating current from an external power source “A” into a direct current and, in addition to this, converts an external voltage from the external power source “A” into a voltage for the secondary battery. The secondary battery 2 is charged by connecting the converter 13 to, for example, an external power source such as an outlet for household appliances. The secondary battery 2 supplies electric power to the electric motor 5 via an inverter 12 which converts a direct current into an alternating current.

The distributor 14 connects or disconnects the external power source “A” to or from the secondary battery 2, the water pump 17, and the electric ion removing device 20, respectively.

The fuel cell vehicle 1 is provided with a controller 22 which operates and controls the electric motor 5, the fuel cell device 3, and the electric ion removing device 20 on the basis of an operating state of the vehicle 1.

When a main switch 23 is turned on, the controller 22 rotatably drives the wheel 4 by the electric motor 5 mainly with the secondary battery 2 as a power source according to an amount of an operation of an accelerator by a rider.

When the amount of the battery charge of the secondary battery 2 becomes equal to or lower than a predetermined value during running, the controller 22 operates the fuel cell device 3. The secondary battery 2 is charged by electricity generated by the fuel cell device 3. When the amount of the battery charge of the secondary battery 2 exceeds the predetermined value, the fuel cell device 3 is stopped.

When the fuel cell device 3 starts an operation, the controller 22 also operates the water pump 17. The cooling water is circulated by the water pump 17 through the circulation pipeline 16. As a result, the fuel cell 6 is cooled and kept at a predetermined temperature.

Further, when the conductivity of the cooling water exceeds a predetermined value while the fuel cell device 3 is operating, the controller 22 operates the electric ion removing device 20. As a result, electroconductive ions in the cooling water are removed.

The controller 22 supplies a battery charge power source “a”, a pump operation power source “b”, and a device operation power source “c” to the secondary battery 2, to the water pump 17, and to the electric ion removing device 20, respectively, via the distributor 14 from the external power source “A”. In this case, the controller 22 and the distributor 14 function as a power source controller.

The controller 22 operates the water pump 17 to circulate the cooling water via the circulation pipeline 16 when the fuel cell device 3 is not operated and when the external power source “A” is connected to the secondary battery 2 for charging the battery. In this case, the controller 22 and the distributor 14 function as a pump operation controller. Specifically, while the main switch 23 is off, if the external power source “A” is connected to the secondary battery 2, then the water pump 17 is operated and the electric ion removing device 20 is operated.

When the amount of the battery charge of the secondary battery 2 exceeds the predetermined value and, thus, the battery charging is ended, the controller 22 stops supplying the battery charge power source “a” to the secondary battery 2 via the distributor 14 and continues supplying the pump operation power source “b” to the water pump 17 and the device operation power source “c” to the electric ion removing device 20.

The controller 22 operates the water pump 17 with an output lower than that for a normal operation during battery charging. Specifically, the amount of electricity supplied to the water pump 17 is controlled so that a flow amount of the cooling water is less than that during an operation of the fuel cell device 3.

When connection of the external power source “A” to the secondary battery 2 is disabled, the controller 22 stops operating the electric ion removing device 20 and also stops operating the water pump 17.

An operation of the controller 22 will be described hereinafter with reference to the flow chart in FIG. 2.

In step S1, when the main switch 23 is turned on, and the amount of the battery charge of the secondary battery 2 is read (step S2). If the amount of the battery charge is equal to or lower than the predetermined value, the fuel cell device 3 is operated, and the water pump 17 is operated in a normal output mode (steps S3 and S4). As a result, the fuel cell 6 is cooled by the cooling water and generates electricity for charging the secondary battery 2.

In step S1, when the main switch 23 is off, if the external power source “A” is connected to the secondary battery 2 (step S5), a control system route of the distributor 14 is connected (step S6), and the battery charge power source “a” is supplied to the secondary battery 2. Then, the pump operation power source “b” is supplied to the water pump 17 via distributor 14, the device operation power source “c” is supplied to the electric ion removing device 20, the water pump 17 is operated in a LOW mode, and the electric ion removing device 20 is operated (steps S6, S9, and S10). Accordingly, charging of the battery is continued until the amount of the battery charge of the secondary battery 2 reaches the specified value (steps S7 to S8).

In step S7, when the amount of the battery charge of the secondary battery 2 reaches the predetermined value, the supply of the battery charge power source “a” to the secondary battery 2 is stopped by the distributor 14 (step S11). In this case, the pump operation power source “b” to the water pump 17 and the device operation power source “c” to the electric ion removing device 20 are continued.

In step S5, when connection of the external power source “A” to the secondary battery 2 is disabled, the device operation power source “c” to the electric ion removing device 20 is stopped via the distributor 14, and the pump operation power source “b” to the water pump 17 is stopped (steps S12 to S14). Further, even if the external power source “A” is connected to the secondary battery 2, when the main switch 23 is turned on, the device operation power source “c” to the electric ion removing device 20 and the pump operation power source “b” to the water pump 17 are stopped.

According to the present preferred embodiment described above, while the main switch 23 is off, and therefore when the fuel cell device 3 is not operated, if the external power source “A” is connected to the secondary battery 2, the water pump 17 is operated to circulate the cooling water via the circulation pipeline 16. Accordingly, it is possible to prevent the cooling water from being corroded due to stagnant cooling water and to prevent the cooling water from freezing in cold weather. As a result, even if there are frequent cases in which the secondary battery 2 is mainly used as a power source and the fuel cell device 3 is not used very much during running, it is possible to prevent the cooling water from deteriorating at an early stage, and it is also possible to prevent the fuel cell device 3 from being damaged due to freezing of the cooling water. In addition, consumption of the hydrogen gas can be reduced.

Further, the water pump 17 is operated and the electric ion removing device 20 is also operated. Accordingly, it is possible to prevent the cooling water from deteriorating, and it is also possible to remove electroconductive ions at the same time.

According to a preferred embodiment, the water pump 17 is automatically operated merely by connecting the external power source “A” to the secondary battery 2. Accordingly, any manual operation for circulating the cooling water is not necessary.

According to a preferred embodiment, when connection of the external power source “A” to the secondary battery 2 is disabled, the operation of the water pump 17 is stopped. Accordingly, any manual operation for stopping the water pump 17 is not necessary.

According to a preferred embodiment, the water pump 17 is operated with an output lower than that for a normal operation. Accordingly, the output is lower than that for cooling the fuel cell 6, in other words, an output of a minimum requirement for circulating the cooling water is only necessary. As a result, power consumption can be reduced.

According to a preferred embodiment, the electric ion removing device 20 which decreases conductivity of the cooling water flowing in the circulation pipeline 16 is arranged in the circulation pipeline 16. Accordingly, an operation for removing conductive ions from the cooling water can be performed at the same time when the cooling water is circulated. As a result, any special operation for decreasing the conductivity of the cooling water is not necessary.

According to a preferred embodiment, the battery charge power source “a”, the pump operation power source “b”, and the device operation power source “c” are separately supplied to the secondary battery 2, to the water pump 17, and to the electric ion removing device 20, respectively, via the distributor 14 from the external power source “A”. Accordingly, when the amount of the battery charge of the secondary battery 2 exceeds the specified value and charging the battery is ended, only the supply of the battery charge power source “a” to the secondary battery 2 is ended, and the power sources “b” and “c” to the water pump 17 and the electric ion removing device 20 can be continued. As a result, circulation of the cooling water and the operation for removing ions can be continued.

Further, the power sources “b” and “c” for operating the water pump 17 and the electric ion removing device 20, respectively, are supplied from the external power source “A”. Accordingly, it is possible to avoid a case in which the amount of the battery charge of the secondary battery 2 is unnecessarily reduced in the case in which the secondary battery 2 is a power source.

In a preferred embodiment, when charging of the secondary battery 2 is ended, only the supply of the battery charge power source “a” to the secondary battery 2 is ended. However, in another preferred embodiment, when the battery charge power source “a” to the secondary battery 2 is stopped, the device operation power source “c” to the electric ion removing device 20 may also be stopped at the same time. In this case, only the operation of the water pump is continued. Consequently, it is possible to avoid a problem in which the electric power of the secondary battery 2 is unnecessarily reduced in the case in which the secondary battery 2 is a power source. In addition, the amount of power consumption of the external power source “A” can be reduced.

Further, in a preferred embodiment, when the external power source is connected to the secondary battery, the ion removing device is operated with the water pump. However, in another preferred embodiment, only the water pump may be operated without operating the ion removing device. In this case, as the cooling water is circulated, it is possible to prevent the cooling water from being corroded or from freezing in cold weather.

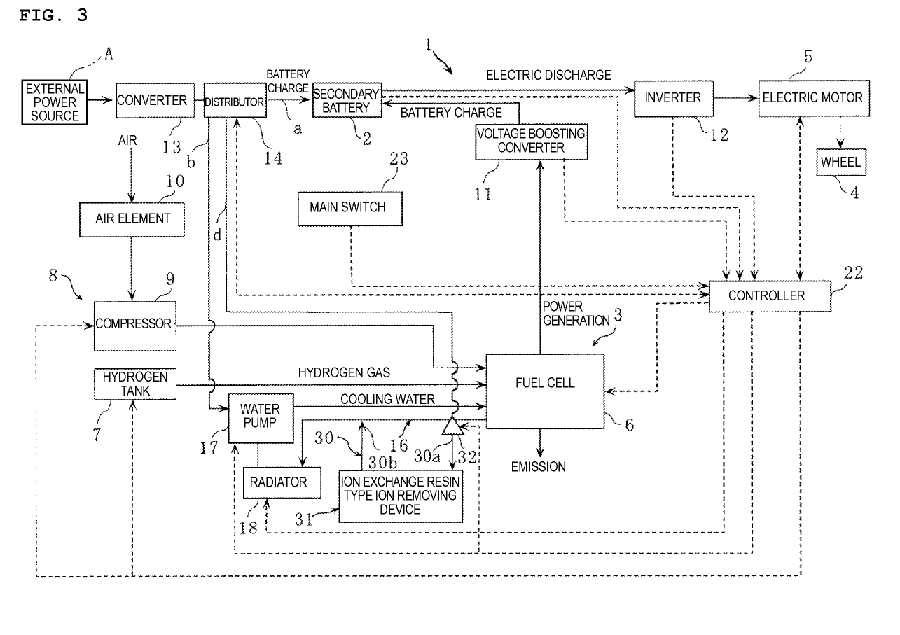

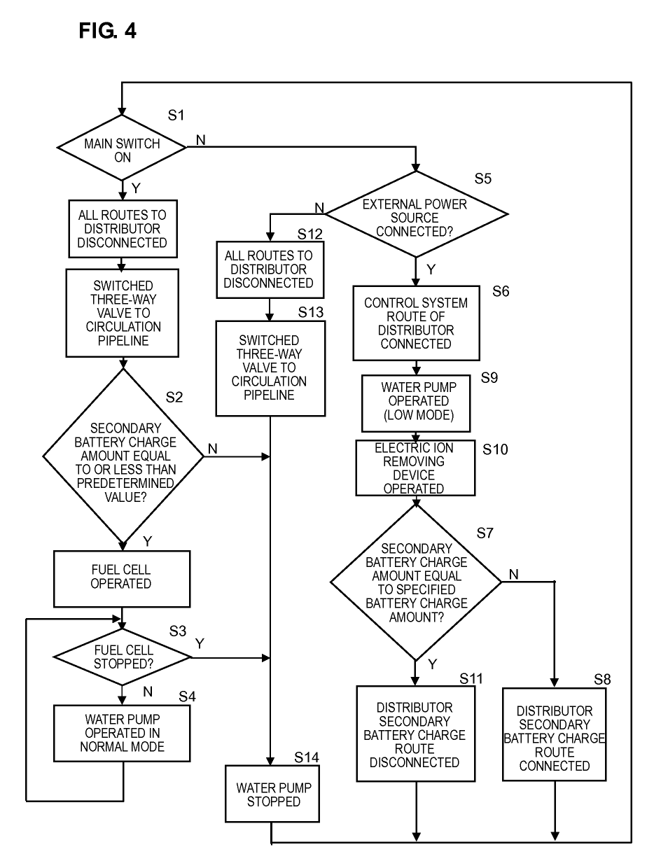

FIG. 3 and FIG. 4 are drawings for describing a fuel cell vehicle according to a second preferred embodiment of the present invention. In FIG. 3 and FIG. 4, the features and steps indicated with the same reference numerals and symbols as those in FIG. 1 and FIG. 2 are the same as or similar to the corresponding features and steps.

A fuel cell vehicle 1 in the present preferred embodiment is provided with a secondary battery 2 mounted on a vehicle (not shown), a fuel cell device 3, and an electric motor 5 supplied with electricity by at least one of the secondary battery 2 and the fuel cell device 3 to rotatably drive the wheel 4. In addition, since a basic structure is generally the same as that in the first preferred embodiment, only different features will now be described.

The fuel cell vehicle 1 in the present preferred embodiment has a bypass pipeline 30 connected between the fuel cell device 3 and the radiator 18 of the circulation pipeline 16 thus bypassing the circulation pipeline 16, an ion exchange resin type ion removing device 31 arranged in the bypass pipeline 30, and an electromotive three-way valve 32 for permitting or restricting a flow of the cooling water to the bypass pipeline 30. In this case, the bypass pipeline 30, the ion exchange resin type ion removing device 31, and the electromotive three-way valve 32 function as the conductivity decreasing device. Also, the electromotive three-way valve 32 functions as a switch.

The electromotive three-way valve 32 is provided in a connecting section between an upstream end 30a of the bypass pipeline 30 and the circulation pipeline 16. The electromotive three-way valve 32 is switched to either a bypass position which leads the cooling water discharged from the fuel cell device 3 to the bypass pipeline 30, or a circulation position which circulates the discharged cooling water from the circulation pipeline 16 to the radiator 18. The electromotive three-way valve may be provided in a connecting section between a downstream end 30b of the bypass pipeline 30 and the circulation pipeline 16.

The controller 22 separately supplies the battery charge power source “a”, the operation power source “b”, and a switching power source “d” to the secondary battery 2, to the water pump 17, and to the electromotive three-way valve 32, respectively, via the distributor 14 from the external power source “A”. When the amount of the battery charge of the secondary battery 2 exceeds a specified value, the supply of the battery charge power source “a” to the secondary battery 2 is stopped via the distributor 14.

As illustrated in the flow chart in FIG. 4, while the main switch 23 is off (step S1), if the external power source “A” is connected to the secondary battery 2, a control system route of the distributor 14 is connected (steps S5 and S6). Consequently, the battery charge power source “a” is supplied to the secondary battery 2, and the switching power source “d” is supplied to the electromotive three-way valve 32. Moreover, the pump operation power source “b” is supplied to the water pump 17. As a result, the battery charge is continued until the amount of the battery charge of the secondary battery 2 reaches the specified value (steps S7 to S8). At the same time as this, the electromotive three-way valve 32 is switched to the bypass pipeline 30, and the water pump 17 is operated in the LOW mode (steps S9 and S10′). The cooling water discharged from the fuel cell device 3 flows through the bypass pipeline 30 and, after electroconductive ions are removed by the ion removing device 31, the cooling water is returned to the circulation pipeline 16 and circulated by the route passing through the radiator 18.

In step S7, when the amount of the battery charge of the secondary battery 2 reaches the predetermined value, the supply of the battery charge power source “a” to the secondary battery 2 is stopped by the distributor 14 (step S11). In this case, the pump operation power source “b” to the water pump 17 and the switching power source “d” to the electromotive three-way valve 32 are continued.

In step S5, when connection of the external power source “A” to the secondary battery 2 is disabled, all routes to the distributor 14 are disconnected (step S12). Consequently, the supply of the switching power source “d” to the electromotive three-way valve 32 is stopped, and the pump operation power source “b” to the water pump 17 is stopped (steps S13′ and S14). As a result, the flow of the cooling water to the fuel cell device 3 is stopped.

According to the present preferred embodiment, the ion exchange resin type ion removing device 31 and the electromotive three-way valve 32 are arranged in the bypass pipeline 30 bypassing the circulation pipeline 16, and the battery charge power source “a”, the operation power source “b”, and the switching power source “d” are supplied to the secondary battery 2, to the water pump 17, and to the electromotive three-way valve 32, respectively, via the distributor 14 from the external power source “A”. When the amount of the battery charge of the secondary battery 2 exceeds the specified value, the supply of the battery charge power source “a” to the secondary battery 2 is stopped. Accordingly, even when the battery charge of the secondary battery 2 is ended, the power source “d” for operating the electromotive three-way valve 32 can be supplied from the external power source “A”. As a result, it is possible to avoid a case in which the amount of the battery charge of the secondary battery is unnecessarily reduced in the case in which the secondary battery 2 is the power source.

In the second preferred embodiment, a case in which the flow of the cooling water to the bypass pipeline is permitted or restricted by the electromotive three-way valve is described. However, in another preferred embodiment of the present invention, a three-way valve of an automatic temperature sensing type may be used. When the three-way valve of an automatic temperature sensing type is used, the power source for operating the switch is not necessary.

The three-way valve of an automatic temperature sensing type preferably contains a shape memory alloy. When the temperature of the cooling water reaches a specified temperature, the route of the cooling water is switched from the circulation pipeline 16 to the bypass pipeline 30 or from the bypass pipeline 30 to the circulation pipeline 16.

For example, when the specified temperature of the shape memory alloy is about 50° C., for example, if the cooling water reaches about 50° C. as a result of an operation of the fuel cell device, the route of the flow is automatically switched to the circulation pipeline. When the fuel cell device is operated, the temperature of the cooling water is increased to about 60° C. in a short time.

When the temperature of the cooling water is about 50° C. or higher, the cooling water does not flow to the ion removing device 31, which resists the flow. Accordingly, the fuel cell device 3 is efficiently cooled, and it is possible to avoid a problem in which the ion removing device 31 is damaged because of a high temperature of the cooling water.

On the other hand, if the temperature of the cooling water is lower than about 50° C., the route of the cooling water is automatically switched to the bypass pipeline 30. Consequently, the cooling water flows from the bypass pipeline 30 to the ion removing device 31.

When the vehicle is stopped or parked, the fuel cell device 3 is not operated. Accordingly, the temperature of the cooling water becomes as low as the outside air temperature. Consequently, the cooling water passes through the ion removing device 31, and ions are removed.

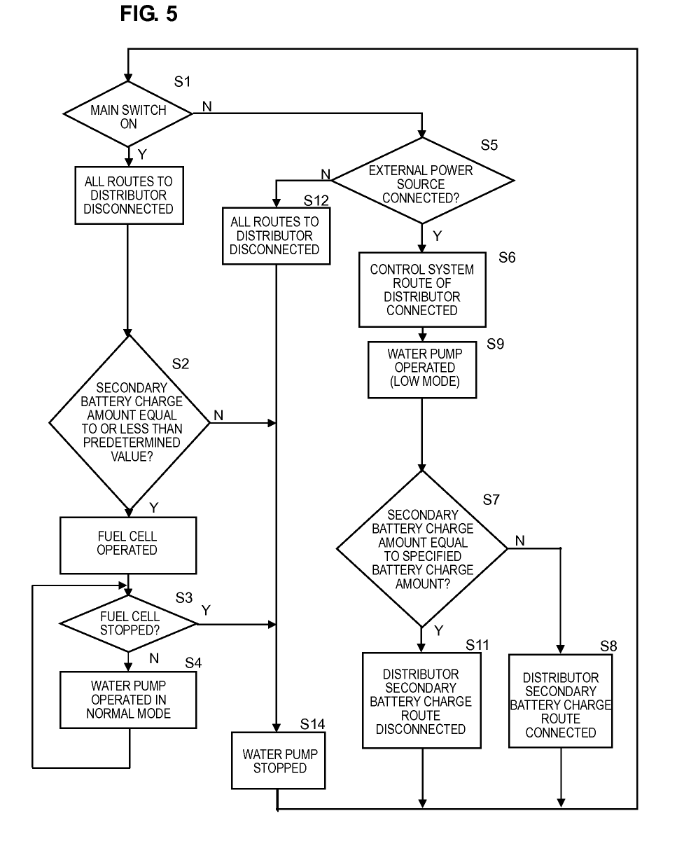

FIG. 5 is a flow chart illustrating an operation in a case in which the three-way valve of an automatic temperature sensing type is used in place of the electromotive three-way valve. In FIG. 5, the steps indicated with the same reference numerals and symbols as those in FIG. 4 are the same as or similar to the corresponding steps.

While the main switch is off (step S1), if the external power source “A” is connected to the secondary battery 2, the battery charge power source “a” is supplied to the secondary battery 2 via the distributor 14 (steps S5 and S6). At the same time as this, the pump operation power source “b” is supplied to the water pump 17 via distributor 14 (step S9). On the other hand, when connection of the external power source “A” to the secondary battery 2 is disabled, the supply of the pump operation power source “b” to the water pump 17 is stopped via the distributor 14 (steps S12 and S14).

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A fuel cell system comprising:
a fuel cell device;
a secondary battery arranged to be chargeable by the fuel cell device;
a cooling system including a water pump arranged to circulate cooling water to cool the fuel cell device via a circulation pipeline; and
a pump operation controller arranged to operate the water pump to circulate the cooling water via the circulation pipeline during a period of time when the fuel cell device is not operated and an external power source arranged to charge the secondary battery is connected to the secondary battery.

2. The fuel cell system according to claim 1, wherein the pump operation controller operates the water pump by electric power from the external power source during the period of time.

3. The fuel cell system according to claim 1, wherein the pump operation controller stops an operation of the water pump when connection of the external power source to the secondary battery is disabled.

4. The fuel cell system according to claim 1, wherein the pump operation controller operates the water pump during the period of time with an output lower than that for when the fuel cell is operated.

5. The fuel cell system according to claim 2, further comprising a conductivity decreasing device arranged to decrease the conductivity of the cooling water flowing through the circulation pipeline.

6. The fuel cell system according to claim 2, further comprising a power source controller arranged to supply electric power to the secondary battery from the external power source during the period of time, wherein the power source controller stops supplying electric power to the secondary battery from the external power source when an amount of a battery charge of the secondary battery exceeds a specified value during the period of time.

7. The fuel cell system according to claim 5, further comprising a power source controller arranged to supply electric power to the secondary battery and the conductivity decreasing device from the external power source during the period of time, wherein the power source controller stops supplying electric power to the secondary battery from the external power source when an amount of a battery charge of the secondary battery exceeds a specified value during the period of time.

8. The fuel cell system according to claim 7, wherein the power source controller stops supplying electric power to the secondary battery and the conductivity decreasing device from the external power source when connection of the external power source to the secondary battery is disabled.

9. The fuel cell system according to claim 7, wherein the conductivity decreasing device includes an electric ion removing device, and the power source controller supplies electric power to the secondary battery and the electric ion removing device from the external power source during the period of time.

10. The fuel cell system according to claim 7, wherein the conductivity decreasing device includes an ion exchange resin type ion removing device arranged in a bypass pipeline bypassing the circulation pipeline, and a switch arranged to permit or restrict a flow of the cooling water to the bypass pipeline, wherein the power source controller supplies electric power to the secondary battery and the switch from the external power source during the period of time.

11. The fuel cell system according to claim 10, wherein the switch includes an electromotive three-way valve.

12. The fuel cell vehicle according to claim 5, wherein the conductivity decreasing device includes an ion exchange resin type ion removing device arranged in a bypass pipeline that is arranged to bypass the circulation pipeline and a switch arranged to permit or restrict a flow of the cooling water to the bypass pipeline, wherein the switch is a three-way valve automatic temperature sensor containing a shape memory alloy arranged to switch a route of the cooling water from the circulation pipeline to the bypass pipeline or from the bypass pipeline to the circulation pipeline when a temperature of the cooling water reaches a specified temperature.

13. A transportation equipment comprising:
the fuel cell system according to claim 1; and
an electric motor arranged to be supplied with electricity by at least one of the secondary battery and the fuel cell device to drive a wheel of the transportation equipment.
